(19) United States
(12) Patent Application Publication
(10) Pub. No.: US 2017/0278170 A1
(43) Pub. Date: Sep. 28, 2017

(54) Method and system for measuring envelope efficiency

(71) Applicant: Thomas G. Davis, Fort Collins, CO (US)

(72) Inventor: Thomas G. Davis, Fort Collins, CO (US)

(21) Appl. No.: 15/468,839

(22) Filed: Mar. 24, 2017

Related U.S. Application Data
(60) Provisional application No. 62/313,503, filed on Mar. 25, 2016.

(51) Int. Cl. G06Q 30/06; G06F 17/30; G06Q 50/16; G01N 25/18

(52) U.S. Cl. CPC G06Q 30/0629; G01N 25/18; G06F 17/30312; G06Q 50/16

(57) ABSTRACT

A method of communicating residential energy efficiency, is provided. The method includes obtaining a data set from a plurality of building structures wherein the data set includes an indoor temperature, an outdoor temperate, and HVAC equipment state information from each of the plurality of building sets. The method further includes determining energy efficiency for each of the plurality of building structures using the indoor temperature, the outdoor temperature and the HVAC equipment state information and displaying energy efficiency for one of the plurality of building structures as a comparison to other of the plurality of building structures.

### PRIORITY STATEMENT

This application claims priority to U.S. Provisional Patent Application 62/313,503, filed on Mar. 25, 2016, and entitled Method and system for measuring envelope efficiency, hereby incorporated by reference in its entirety.

### FIELD OF THE INVENTION

The present invention relates to heating, cooling, and energy efficiency. More particularly, but not exclusively, the present invention relates to measuring residential envelope efficiency and presenting it to take homeowner (or potential buyer) in a way that makes sense, is easy to understand, and meaningful.

### BACKGROUND

America's existing home stock offers tremendous opportunities for energy savings. However, capturing this savings potential within the existing structure of the home improvement market/industry has been challenging. Allowing home owners, renters and potential purchasers to have meaningful information they need to understand the energy efficiency of a given home or what opportunities there might be for improvement is a long-felt need. Having such information would be a great motivator for owners to improve the energy efficiency of the envelope and upgrade equipment and systems in their home. Moreover, the majority of homes tested to date have equipment that is at least double the size required by “Design” conditions at their locations. In fact, many were 3 times larger than needed. Less than 1 percent of homes have HVAC equipment that is within 10% of the actual load presented by the home. Moreover, most of the homes that were tested have duct systems that are too restrictive for the air volumes they are asked to carry. The restrictive duct systems are one of the main reasons that installed equipment cannot deliver lab efficiency. Such problems are only further exacerbated when replaced by higher efficiency equipment.

Homeowners may consult with energy auditors or HVAC technicians; however, they will likely receive little accurate or meaningful information. This is because misdiagnosis is rampant. Both HVAC technicians and energy auditors are evaluating the energy efficiency of the envelope but they do not use the same system and the tools they do use do not work well. For example, Manual J is one method which is used. However, this sizing tool is very subjective with no way to make it more objective. The HVAC technician can make the bottom line be almost any number desired. There is no reason for the technician to be conservative as local inspection authorities will not challenge equipment size. Moreover, the home owner may be complicit because “Bigger is Better” may seem intuitively correct with respect to furnaces or other HVAC equipment sizes. However, although oversized equipment will heat and cool a home, the home owner loses out on energy savings and comfort that is provided my matching equipment to load.

Home owners are generally unaware of the various issues associated with HVAC equipment which lead to increasing heating and cooling costs as well as not being able to maintain desired comfort.

Real estate professionals are a group that could help drive demand if they had access to home performance data. Thousands of homeowners and builders have invested in energy upgrades but have been frustrated by agents, appraisers, and lenders because too often, they have not recognized added value for the upgrades. This has been a detriment to market update as consumers need certainty that these investments in energy upgrades will pay off

Therefore, what is needed are evaluation methods, systems, and apparatuses which address these and other problems relating to heating, cooling, and energy efficiency.

### SUMMARY

Therefore, it is a primary object, feature, or advantage of the present invention to improve over the state of the art.

It is a further object, feature, or advantage of the present invention to measure residential envelope efficiency accurately for existing homes.

It is a still further object, feature, or advantage of the present invention to allow for reporting energy loss/gain by BTU per square foot of living space.

Another object, feature, or advantage is to facilitate comparison of envelope efficiency of any home (or other property) to any other home (or other property).

Yet another object, feature, or advantage is make it easy and convenient for real estate buyers to compare energy efficiency across different properties under consideration.

A further object, feature, or advantage is to provide a measure of energy efficiency which is not dependent upon weather, equipment efficiency or life style of occupants.

A still further object, feature, or advantage is to allow for the actual percentage of efficiency gained from envelope retrofit work to be evaluated.

Another object, feature, or advantage is to allow a property owner to experience all the energy and money savings that go along with matching the HVAC equipment to the load including substantial (e.g. 5% to 10%) energy savings and savings on retrofit of HVAC equipment because of smaller size.

A further object, feature, or advantage is to allow duct systems to carry the CFM required.

Yet another object, feature, or advantage is to provide additional comfort to home owners with quieter, softer, more even temperatures and to allow for properly heating or cooling rooms that were not heated or cooled properly before.

Another object, feature, or advantage is to allow multi-speed equipment to match the actual load so it can deliver the high level of comfort that this technically advanced equipment promises.

A further object, feature, or advantage is to collect energy efficiency measurements for a plurality of different homes (or other properties) to be aggregated so that they may be compared.

A still further object, feature, or advantage is to increase public awareness regarding residential energy efficiency.

Another object, feature, or advantage is to demonstrate how design and installation influence residential HVAC capacity and efficiency.

Yet another object, feature, or advantage is to lower energy use for individual homeowners as well as across the country.

A further object, feature, or advantage is to provide for longer life expectancy of HVAC equipment through proper sizing.

A still further object, feature, or advantage is to reduce service requirements for HVAC equipment through proper sizing.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a method of accurately measuring residential energy efficiency is provided. The energy loss/gain may be reported by BTU per Sq. Ft. of living space. The method may further include comparing the residential energy efficiency of different homes. The method may further include determining the effect of improvements to the home such as the percentage of effect on energy efficiency made by the improvements. The method may further include determining the size of HVAC equipment.

According to another aspect, a method of communicating residential energy efficiency, is provided. The method includes obtaining a data set from a plurality of building structures wherein the data set includes an indoor temperature, an outdoor temperate, and HVAC equipment state information from each of the plurality of building sets. The method further includes determining energy efficiency for each of the plurality of building structures using the indoor temperature, the outdoor temperature and the HVAC equipment state information and displaying energy efficiency for one of the plurality of building structures as a comparison to other of the plurality of building structures.

According, to another aspect, a method of collecting and sharing energy efficiency on a comparative basis is provided. The method includes collecting HVAC equipment state information, associating indoor temperature data and outdoor temperature data with the HVAC equipment state information, determining using a processor, energy efficiency for the building structure using the indoor temperature data, the outdoor temperature data, and the HVAC equipment state information, and displaying energy efficiency for the building structure in comparison to a plurality of other building structure to show the energy efficiency for the building structure on the comparative basis.

According to another aspect, a system for determining residential energy efficiency for a home includes an inside temperature sensor for collecting indoor temperature data associated with the home, an outside temperature sensor for collecting out door temperature data associated with the home, and a sensor for determining cycling on and off of HVAC equipment of the home. The system further includes a computing device in operative communication with the inside temperature sensor, the outside temperature sensor, and the sensor determining cycling on and off data for the HVAC equipment and a database storing the inside temperature data, the outside temperature data, and the cycling on and off data for the HVAC equipment in the home and in a plurality of different homes. The computing device is in operative communication with the database to provide for determining energy efficiency of the home and to provide comparison of the energy efficiency of the home with the plurality of different homes.

According to another aspect, a method of collecting and sharing energy efficiency on a comparative basis is provided. The method includes collecting audio of HVAC equipment within a home cycling on and off using a microphone. The method further includes analyzing the audio of the HVAC equipment to determine HVAC equipment state information indicating the cycling on and off of the HVAC equipment. The method further includes associating indoor temperature data and outdoor temperature data with the HVAC equipment state information. The method further includes determining using a processor, energy efficiency for the building structure using the indoor temperature data, the outdoor temperature data, and the HVAC equipment state information. The method further includes displaying energy efficiency for the building structure in comparison to a plurality of other building structures to show the energy efficiency for the building structure on the comparative basis.

### BRIEF DESCRIPTION OF THE DRAWINGS

FIG. 1 illustrates one example of an illustration which may be used to convey energy efficiency of a home in BTU per square foot.

FIG. 2 illustrates one example of a system for collecting and analyzing energy efficiency data.

FIG. 3 illustrates another example of a system for collecting and analyzing energy efficiency data.

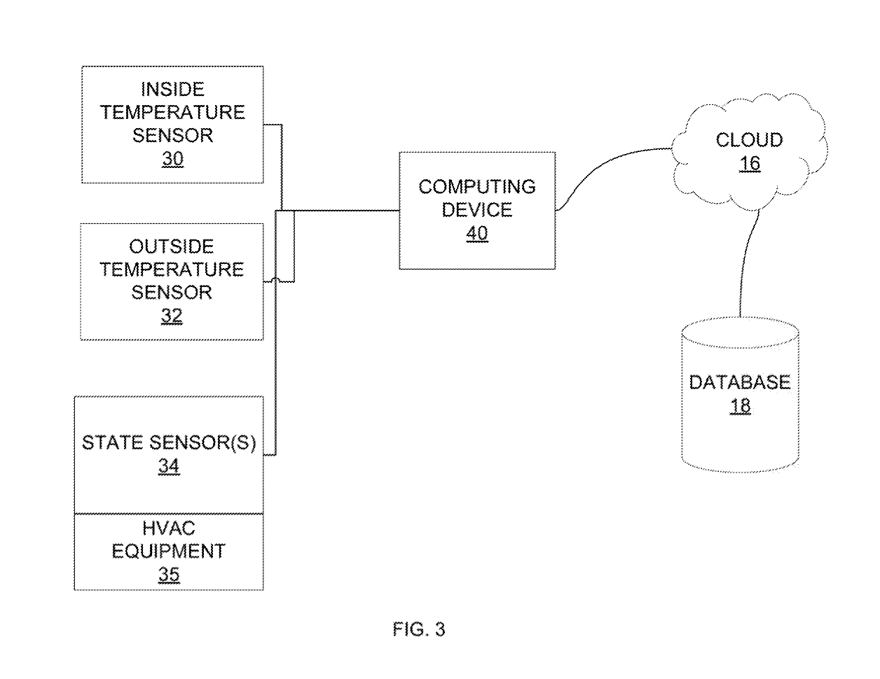

FIG. 4 illustrates an example of a display where energy efficiency of a home is compared to the energy efficiency of other homes across the country.

FIG. 5 illustrates an example of a display where energy efficiency of a home is compared to energy efficiency of other homes in geographical areas having the same design temperature.

FIG. 6 illustrates an example of a display where the energy efficiency of a home is expressed as a percentage or percentile ranking for a set of homes.

FIG. 7 illustrates an example of a display where energy efficiency of a home is compared to energy efficiency of other homes in geographical areas having the same accumulated degree days.

FIG. 8 illustrates one example of a method relating to, comparative energy efficiency.

### DETAILED DESCRIPTION

The present invention relates to methods, apparatuses, and systems of measuring residential energy efficiency and conveying that information. The methodology used in U.S. Pat. No. 7,072,727, herein incorporated by reference in its entirety, may be used to measure energy efficiency in homes, in particular, information concerning inside temperature, outside temperature, and cycling data may be collected and used.

According to one aspect, methods, and devices are provided which may be used by home owners, building owners, contractors, energy companies, or others to scientifically collect and process the data needed to determine energy efficiency. In some embodiments, such information can be easily and conveniently collected by home owners.

According to another aspect, methods and systems are provided which may be used to convey to home owners or others results of an analysis of energy efficiency. Such information may be used for various purposes. This may include guiding an individual looking to increase energy efficiency of their home, comparing the relative energy efficiency of homes where an individual is considering buying a home or selling a home. This information may also be used to size furnaces or other HVAC equipment, provide guidance as to whether increased insulation or other energy efficiency upgrades will be significantly helpful, or otherwise assist a homeowner or building owner in evaluating, understanding, and making decisions based on energy efficiency.

For example, oversized equipment may be used to heat and cool a home. Thus, in many instances the equipment installed within a home is oversized. In fact, based on testing to date, the great majority of homes have equipment that is at least double the size required by design conditions at their location. Many are even three times larger than needed. Less than 1 percent of homes have HVAC equipment that is within 10 percent of the actual load presented by the home. Such results are counter-intuitive to home owners as well as HVAC contractors. Many individuals operate under the mistaken assumption that bigger is better. Thus, for example, they believe that a furnace with a higher BTU output is better. Some individuals may even pay extra to purchase such a furnace. Thus, there are situations where an individual will pay more to buy a bigger furnace and the result will be less energy efficiency, and less comfort than if they had paid less and purchased an appropriately sized furnace.

An oversized furnace will cycle on less frequently than desirable. This can result in some rooms within a home or other building or structure having uncomfortable temperature differentials for the occupants. Thus, for an example, a room may always seem cold because the furnace does not cycle on sufficiently long to deliver the required amount of warm air to the room. Thus, shorter on-time by an over-sized furnace can lead to a loss in comfort which is not typically understood or appreciated by individuals. Thus, home owners are generally unaware of the various issues associated with HVAC equipment which lead to increasing heating and cooling costs as well as not being able to maintain desired comfort. Also, longer heat exchanger life expectancy and less service is required where there is less cycling because equipment remains on for a longer time period.

In addition, many duct systems are too restrictive for the air volumes they are asked to carry. This is one of the main reasons that installed equipment cannot deliver lab efficiency. This problem is exacerbated when replaced by higher efficiency equipment as they require larger volumes of air. Thus, such issues can be reduced or eliminated by proper sizing of furnaces since most are way over-sized.

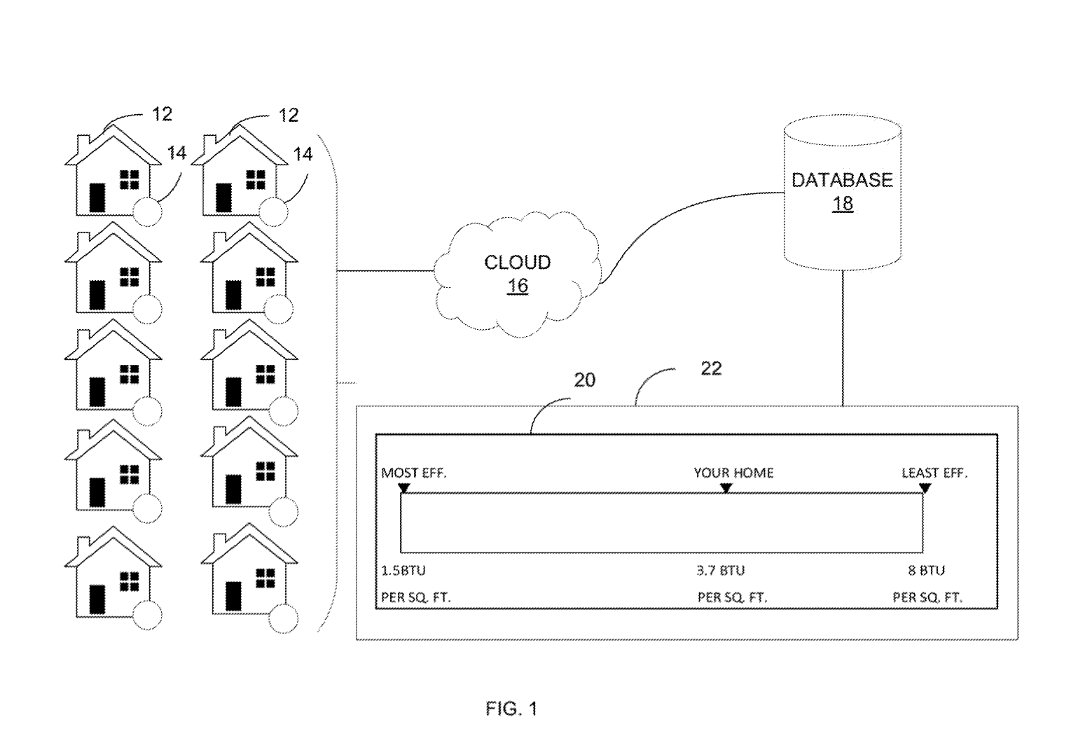

FIG. 1 illustrates one example of a system for comparative analysis of energy efficiency. As shown in FIG. 1 there are a plurality of houses 12 or other buildings or structures. Each of these houses 12 has an associated measurement system 14 associated with it. It is to be understood that although each house 12 could have a single dedicated measurement system 14 which is always available, the measurement system 14 need only be present to collect data used in the comparison. Thus, for example, a single measurement system 14 may be moved from home to home to collect data. The measurement systems may be operatively connected through a network such as a cloud network 16 which may include any number of intermediary devices (not shown). Also, connected directly or indirectly to the cloud 16 is a database 18. The database 18 may be used to store data collected from the measurement systems 14 or the results of analysis of data collected from the measurement systems 14. Such results may be archived within the database 18 for comparison.

The database 18 may include data from a plurality of different homes or structures and may provide for presenting data in any number of different ways. For example, data, may provide for showing a spectrum of energy efficiency showing a per square foot energy use for a set of homes and show where an individual homeowner's home falls within the spectrum as shown in the display 20, the display 20 associated with a computing device 22.

The database 18 may be used in any number of different ways or by any number of different panics depending upon the particular implementation. In one application, the database 18 may he associated with a real estate related web site such as may be associated with a real estate sales organization, a real estate listing service, a government entity tracking energy efficiency or real estate records, an HVAC equipment manufacturer or sales organization, an energy or power company, an independent organization, or any number of other parties.

It is beneficial to have the database 18 with analyses from multiple different homes in order to provide a basis for comparison, especially multiple different homes within the same geographical area. However, it is also appreciated that in some instances, individuals may not be interested in sharing the data from their home with others. Therefore, it is contemplated that any such concerns may be addressed in any number of different ways. This may include providing incentives, whether monetary or otherwise to individuals. Thus, for example, in exchange for providing an analysis of measurement data collected at a home or in partial exchange for providing an analysis of measurement data collected at a home, the homeowner agrees to make the data available within the database 18. The data in the database 18 may include demographic information and may or may not include personally identifiable information. Thus, in some examples, a home may be classified as within a particular geographic area, as having a particular square footage, and other information used in computing energy efficiency without providing a name of the owner or a street address for the home.

The measurement system 14 may be used to accurately measure envelope efficiency and allows for reporting energy loss/gain by BTU per Sq. Ft. of living space. This allows the envelope efficiency of any home to be compared to any other and results in the ability to compare different homes in a manner that is not dependent upon weather, equipment efficiency, or lifestyle of occupants.

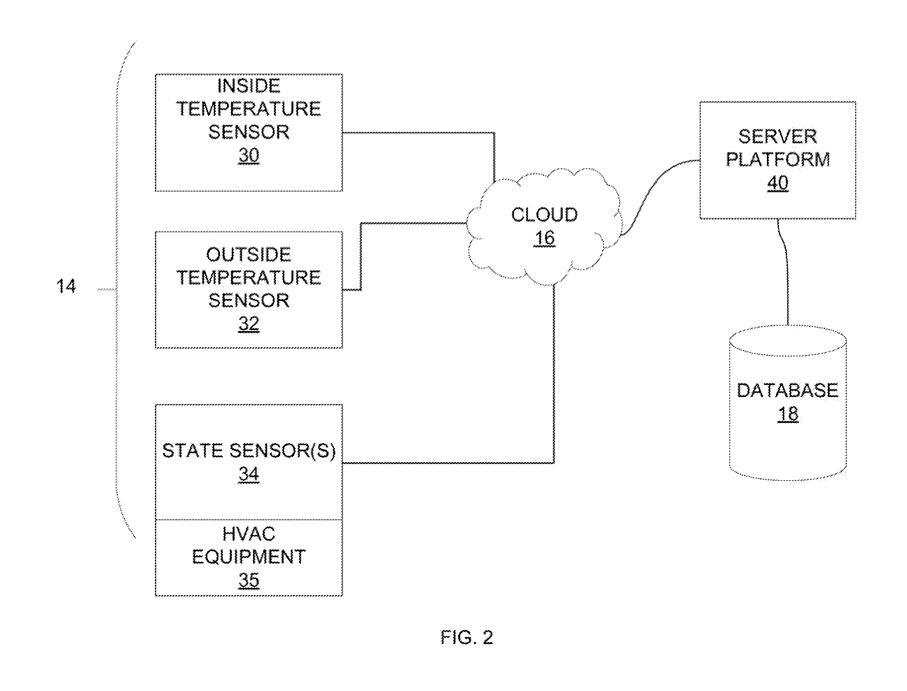

FIG. 2 illustrates one example of a system. As shown in FIG. 2, the measurement system 14 includes an inside temperature sensor 40, an outside temperature sensor 32, and one or more state sensors 34 such as may be used to determine the cycling on or off of a furnace or other item of HVAC equipment or other large generators of heat such as hot tubs, fish tanks, etc. In this example, data from the inside temperature sensor 30, the outside temperature sensor 32, and the state sensor(s) 34 associated with HVAC equipment 35 (such as a furnace or air condition) may be communicated through a cloud network 16 to a server platform 40. The server platform 40 may then perform an analysis using the data to determine any number of useful metrics including BTUs per square foot. The outside temperature sensor may be placed outside of the home. The inside temperature sensor may be placed within the home.

In one embodiment, data may be collected using internet-of-things technologies. A state sensor 34 may be operatively connected to an existing finance. The furnace is used to produce heat to increase the inside temperature of a home or other structure above an outside temperature. The state sensor 34 may have leads for connecting to a furnace or other HVAC equipment. If needed, appropriate isolation circuitry may also be provided. In some embodiments, the sensor 34 may provide a dock to collect date and time information and a memory to store the data which is collected. The data collected can include the date and time of each cycling of a furnace. Alternatively, when the furnace is cycled, this information may be communicated from the sensor 34 to another device which can record the time of the cycling. For example, in some embodiments time and date information may be added at the server platform 40 or by an intermediary network device.

In an alternative embodiment, one or more microphones may be used as the state sensor(s) 34 to listen to HVAC equipment 35 such as a furnace and detect when the furnace cycles on or off based on the sound of the furnace. One of the advantages of such an embodiment is that an individual need not connect any device electrically to the furnace. The microphone may be a part of an independent sensor which may include a wireless interface. It is to be further understood that in some embodiments instead of using a dedicated microphone as a sensor, microphones of other devices may be used. For example, the microphone may be part of another device such as a mobile device, or a smart device such as a smart speaker such as the Amazon Echo or the Google Home. In such embodiments audio associated with the furnace or other HVAC equipment may be analyzed either locally or in the cloud such as at server platform 40 to detect cycling of the furnace or other HVAC equipment.

It is to be further understood that in some instances additional data may be collected as part of the analysis. Such data may be collected from appliances, hot tubs, fish tanks, or other devices. In particular, the stare of different appliances or other devices which consume power and generate heating or cooling effects may be monitored. In addition, the presence or absence of people or pets within the home may be determined. Solar data may also be collected if measurements are taken during the day. In addition, multiple indoor temperature sensors may be used. Such data, if available, may be used to provide appropriate adjustments to calculations regarding energy efficiency and be used for additional analysis, however, such information is not needed. Various types of analysis may be performed. For example, in addition to being used to compare different home, the methodology may be used to determine changes in envelope efficiency. Thus, for example, measurements may be taken before insulation is added, windows are replaced, cracks or leaks are sealed, etc. and then after and the difference determined.

It is also to be understood that in some embodiments, one or more sensors may be incorporated into control systems. For example, the inside temperature sensor may be a temperature sensor included as a part of an electronic thermostat controls such as used by NEST or Carrier or otherwise. It is noted that electronic thermostats may not necessarily provide a constant temperature because they sometimes anticipate outdoor temperature changes instead of merely monitoring temperature changes and acting as a switch. It is also contemplated that if indoor temperature remains at a known constant than indoor temperature need not be measured. It is further contemplated that in some embodiments a furnace or other HVAC equipment may have sensors built-in and may include an interface to a communications network built-in. For example, a furnace may include a wired or wireless network interface to communicate with other devices.

It is also to be understood that instead of the homeowner needing to place an outside temperature sensor outside of their home, weather data such as available from the National Weather Service (NWS), or otherwise obtained may be used to approximate the outside temperature sensor. Although there can be a difference between the actual outside temperature of a home and temperature obtained at a relatively close location, this difference has little measurable effect on the results if an average of data over a longer time period is taken. If measurements are being taken for a single night or day, then obtaining an outside temperature of the home at the home becomes more important to the accuracy of the data.

As shown in FIG. 2, information from sensors 30, 32, 34 may be communicated over a network such as to a central location. This may be accomplished in manner consistent with home networks, home automation, the Internet of Things (IoT) or otherwise. For example, Bluetooth, Wi-Fi, or other technologies may be used to communicate to a computing device 40 which may in turn communicate such information to a remote server over an available Internet connection through a cloud network 16. Various home automation and smart home technology platforms exist many of which include thermostat, lighting, and appliance control. Such home automation and smart home technology platforms may use internet of things (IoT) technologies to communicate with cloud-based servers through networks. Various types of wireless S communications and protocols may be used to connect between devices including Bluetooth, Wi-Fi, ZigBee, Insteon, Z-Wave, or others.

Energy efficiency for a home (or other property) may be determined and expressed as an, energy unit per area such as in BTUs per square feet. For any home energy efficiency may be determined. Because energy efficiency may be standardized in this manner, comparisons between homes may be performed. This may be particularly helpful to home buyers, real estate agents, or others associated with buying or selling homes because this allows for a true comparison between different homes for energy efficiency as opposed to other ad hoc methods such as looking at utility bills which is not helpful because of differences in loads between different homes. Looking at utility bills is not particularly helpful for a variety of reasons. For example, the energy usage depends upon the number of occupants and their lifestyle and preferences, differences of weather from year to year, differences in days between meter reads, changes in prices of energy units over time, changes in energy efficiency equipment over time, addition or subtraction of other energy-using-equipment other than HVAC, use of setback thermostats, and solar gain change over time. It is contemplated that this information may be collected from a number of different homes. This information may then be made available such as through a central database 18 which is accessible to users either for free or on a subscription basis, or otherwise.

Other types of analysis which may be performed include comparisons over time for the same home. Thus, for example, energy efficiency for a home may be measured prior to energy saving improvements being made and then measured again after energy saving improvements are made. Examples of energy saving improvements may include insulation, repair of leaks, or other types of improvements.

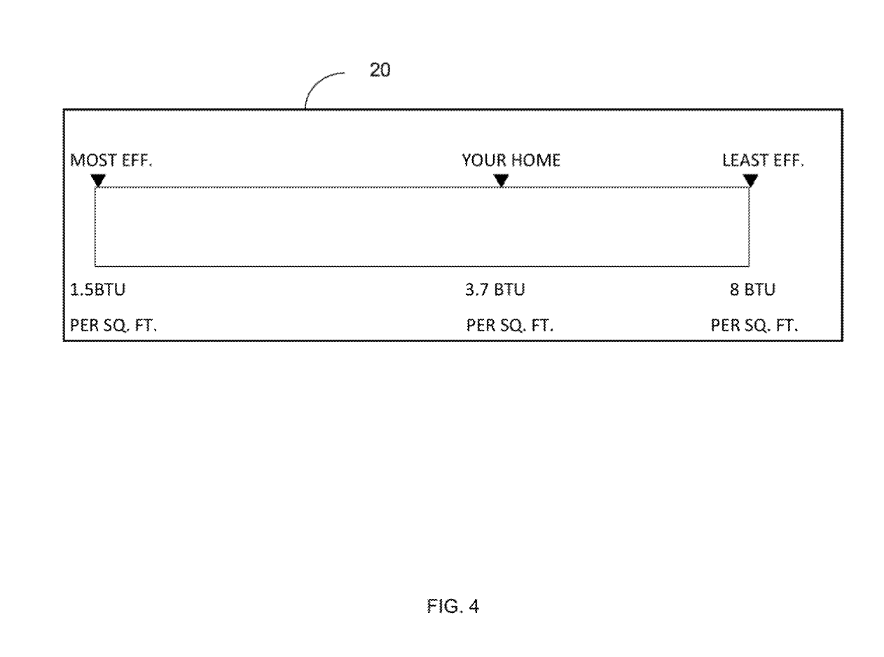

FIG. 4 illustrates one example of information which may be displayed on a display or otherwise conveyed to an individual. This comparison shows the heat loss per sq. ft., of the individual's home, at a 10 degree temperature differential between in and out; this would compare it to the best and worst homes all across the country. It is to be understood that instead of a 10 degree temperature differential, other temperature differentials may be used. It is to be further understood that alternative geographical areas may be used.

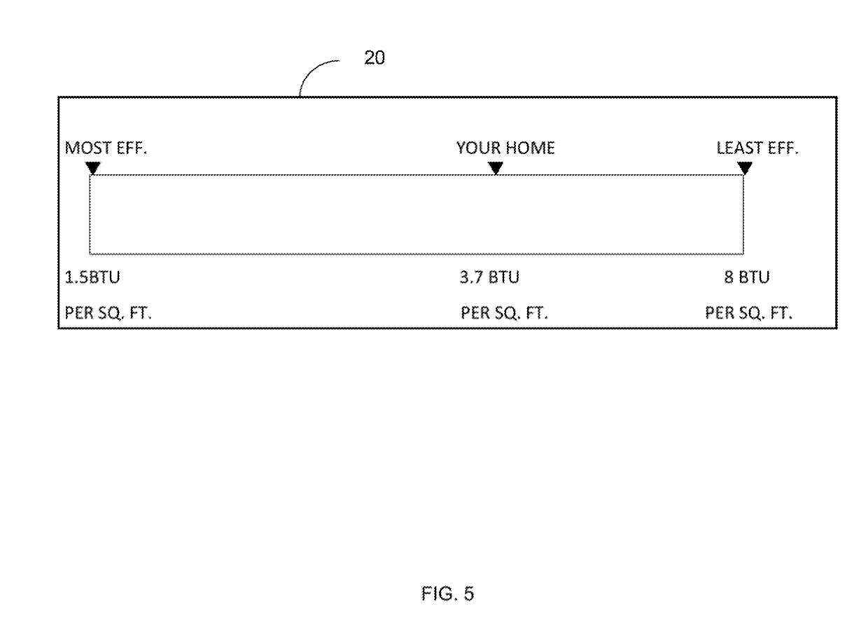

FIG. 5 illustrates one example of information which may be displayed on a display or otherwise conveyed to an individual. This comparison shows the heat loss per sq. ft., of the individual's home, at a 10 degree temperature differential between in and out; this would compare it to the best and worst homes having the same design temperature. Comparison information may be presented based on any number of other factors as well. For example, comparison information may be provided based on cumulative degree days. Thus, only homes with the same number of cumulative degree days are included in the comparison. In, addition, comparisons may take into account other characteristics of homes included. For example, the comparison may be only for new homes, or other characteristics. Information for relative comparisons may be shown in any number of alternative ways.

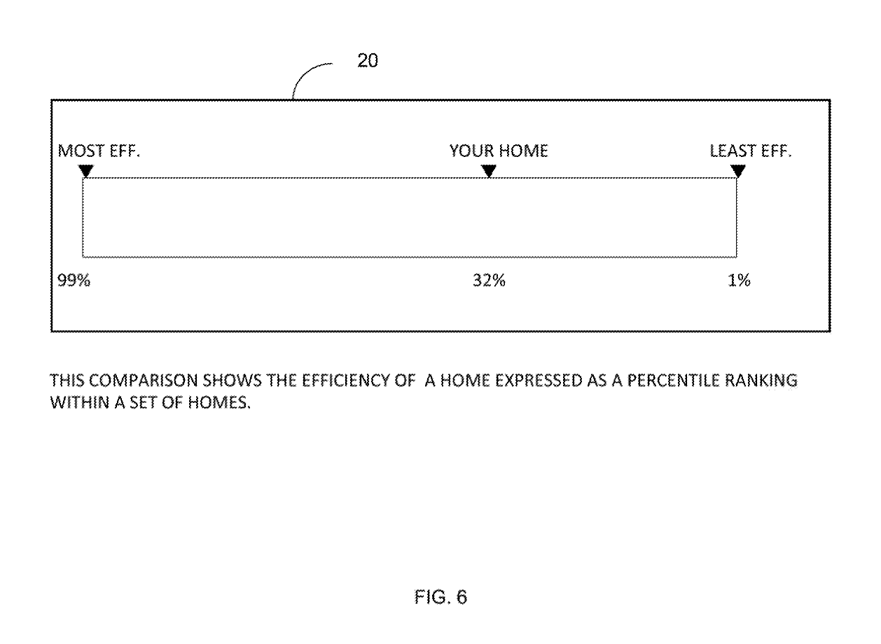

For example, FIG. 6 illustrates an example of a display where the energy efficiency of a home is expressed as a percentage or percentile ranking for a set of homes. In other words, for a group of homes, the percentage is indicative of the number of homes which are more efficient or less efficient than the home of interest (“my home”). One concern with display only a comparison of a home to the best and worst homes within a set is that there may be outliers of highly efficient homes or highly inefficient homes. Displaying the percentage addresses this concern. It is to be further understood that multiple different displays may be combined together such as to show a home owner a comparison of their heat loss per sq. ft. to other homes as well as a percentile ranking of the energy efficiency of their home.

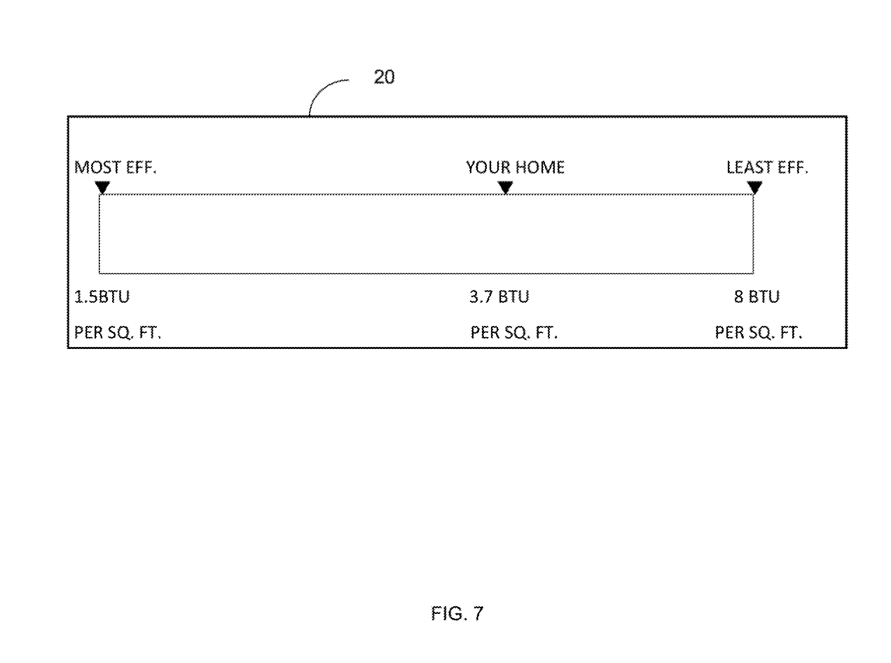

FIG. 7 illustrates an example of a display where energy efficiency of a home is compared to energy efficiency of other homes in geographical areas having the same accumulated degree days. Of course, it is contemplated that relative comparisons may be shown in other ways and the set of homes which are compared may be selected based on other criteria.

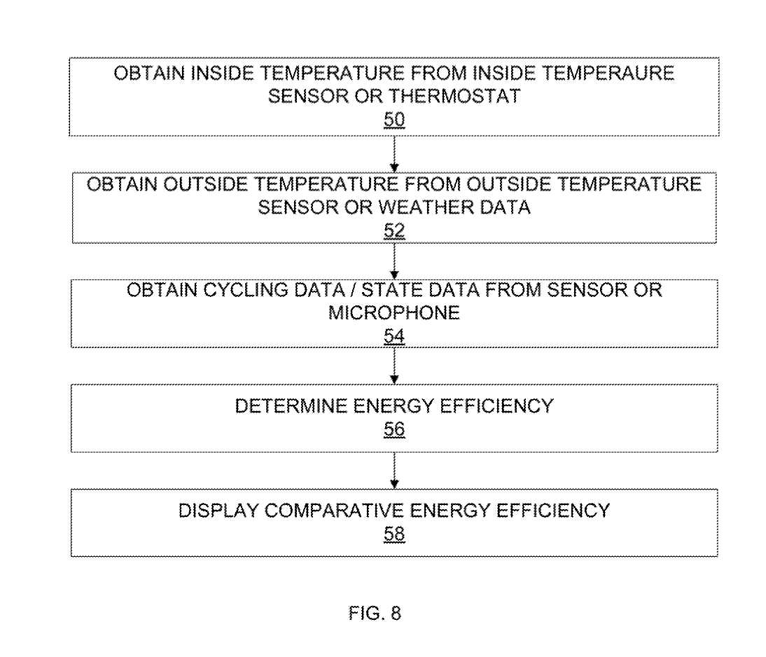

FIG. 8 illustrates one example of a method. In step 50, the inside temperature for a home or other structure is obtained. The inside temperature may be collected using an inside temperature sensor or multiple inside temperature sensors. As previously mentioned, a thermostat may also be used as an approximate of inside temperature, particularly where data is being collected over a longer period of time. The inside temperature data may be stored or communicated over a communications channel or network to a computing device having a processor. In step 52, outside temperature data may be obtained. The outside temperature data may be obtained using an outdoor temperature sensor which stores outside temperature data or wireless communicates the outdoor temperature over a communications channel or network to the computing device. Alternatively, the outside temperature data may be determined for the location of the home or a proximate location of the home. For example, weather data obtained online for nearby locations may be used. The temperature data may be timestamped or otherwise associated with a time. Next in step 54, cycling data or state data from a sensor or microphone is obtained. This data may also be timestamped or otherwise associated with the time it is collected. Based on the inside temperature data, the outside temperature data and the cycling data, the energy efficiency for the home may be determined in step 56. Then in step 58 the energy efficiency of the home may be compared to the energy efficiency of other homes.

America's existing home stock offers tremendous opportunities for energy savings. However, capture this savings potential within the existing structure of the home improvement market/industry has been challenging. Allowing home owners, renters and potential purchasers to have meaningful information they need to understand the energy efficiency of a given home or what opportunities there might be for improvement is a long-felt need. Having such information would be a great motivator for owners to improve the energy efficiency of the envelope and upgrade equipment and systems in their home. Moreover, the majority of homes tested to date have equipment that is at least double the size required by “Design” conditions at their locations. In fact, many were 3 times larger than needed. Less than 1 percent of homes have HVAC equipment that is within 10% of the actual load presented by the home. Moreover, most of the homes that were tested have duct systems that are too restrictive fur the air volumes they are asked to carry. The restrictive duct systems are one of the main reasons that installed equipment cannot deliver lab efficiency. However, such problems are only further exacerbated when replaced by higher efficiency equipment. For example, using multi-speed equipment that does not match the load of a home does not allowing a home owner to obtain the most energy efficiency possible. Therefore, the methods and systems provided fulfill a long-felt need for home owners as reports may be provided in online or written form that provide objective data as well as comparative data.

Whether provided online or in printed form, a report may be given to a home owner. Information which may be included on such a report may include:
Name and contact information for home owner
Name and contact information for technician performing report
Address of home
Date of Test
Begin time and end time for the test
Time that was selected for data utilization
Outdoor temp avg. from utilized hours degrees F
Indoor temp degrees F
Design temp degrees F
Furnace Input BTUs Btus
Furnace Efficiency %
Current Furnace Output Btus Internal Gain utilized in calculations Btus
(Any unusual Internal Gain found by Tech and used in analysis)
(Any unusual cycling patterns that may require a qualified Service Tech to check out)
Sq. Ft. of Home (conditioned space) ft2
Percentage that present furnace is over/under sized %
BTU requirement of home at “Design” (Internal gain+furnace output) Btus
BTU requirements minus Internal Gain (Output of furnace at “Design”) Unusual I.G. not to be subtracted here Btus
Degree of accuracy of current prediction %
BTU requirements per Sq. Ft. at “Design” (for comparing to neighbors) Btu/Ft2
Homes Energy Requirements per Sq. Ft. at a 10 degree temperature difference (for comparing to the rest of the country) Btu/10 ft2
How the Home compares to all others we have tested to date
Percentage of homes that are more or less efficient
Explanations of terms, predictions, estimates and industry standards such as: how “Design” is determined; advantages of a heating/cooling system that matches its load, suggest possible energy and money savings if home energy requirements are above average (adding insulation or tightening up envelope), and energy units (Cubic feet, Gallons, KWH) that could be saved going to a higher efficiency furnace.

Therefore, various method, apparatus, and systems have been provided for measuring, collecting, and comparing energy efficiency of homes or other properties have been provided. This includes incorporation of sensors into smart furnaces or air conditioners alone or as a part of a smart home control system. This further includes the incorporation of the comparative data collected into online real estate web sites or listing services to provide objective energy efficiency information. The present invention is not to be limited to the specific embodiments shown or described herein, but contemplates any number of different options, variations, and alternatives.

What is claimed is:

1. A method of collecting and sharing energy efficiency on a comparative basis, the method comprising:
collecting HVAC equipment state information;
associating indoor temperature data and outdoor temperature data with the HVAC equipment state information;
determining using a processor, energy efficiency for the building structure using the indoor temperature data, the outdoor temperature data, and the HVAC equipment state information;
displaying energy efficiency for the building structure in comparison to a plurality of other building structures to show the energy efficiency for the building structure on the comparative basis.

2. The method of claim 1 wherein the energy efficiency is reported by British Thermal Unit (BTU) per square feet (Sq. Ft.) of living space.

3. The method of claim 1 wherein the plurality of other building structures includes building structures from across the country.

4. The method of claim 1 wherein the plurality of other building structures have a common design temperature.

5. The method of claim 1 wherein the energy efficiency for the building structure comprises a percentile ranking for the building structure within a set comprising the building structure and the plurality of other building structures.

6. The method of claim 1 wherein the energy efficiency is reported both by BTU per Sq. Ft. of living space and as a percentile ranking for the building structure within a set comprising the building structure and the plurality of other building structures.

7. The method of claim 1 wherein the HVAC equipment state is determined using a sensor electrically connected to the HVAC equipment.

8. The method of claim 1 wherein the HVAC equipment state is determined by collecting and analyzing audio of the HVAC equipment cycling on and off.

9. The method of claim 1 wherein the outdoor temperature is determined from an online database.

10. The method of claim 1 wherein the HVAC equipment comprises a furnace.

11. The method of claim 1 wherein the displaying energy efficiency is performed on a real estate web site to allow home buyers to compare the energy efficiency to other homes.

12. The method of claim 1 wherein the determining using the processor, energy efficiency for the building structure further uses state data for appliances within the building structure.

13. The method of claim 12 wherein the determining using the processor, energy efficiency for the building structure further uses occupant data for occupants within the building structure.

14. The method of claim 1 wherein the indoor temperature data is from a thermostat setting.

15. A system for determining residential energy efficiency for a home, the system comprising:
an inside temperature sensor for collecting indoor temperature data associated with the home;
an outside temperature sensor for collecting out door temperature data associated with the home;
a sensor for determining cycling on and off of HVAC equipment of the home;
a computing device in operative communication with the inside temperature sensor, the outside temperature sensor, and the sensor determining cycling on and off data for the HVAC equipment;
a database storing the inside temperature data, the outside temperature data, and the cycling on and off data for the HVAC equipment in the borne and in a plurality of different homes;
wherein the computing device is in operative communication with the database to provide for determining energy efficiency of the home and to provide comparison of the energy efficiency of the home with the plurality, of different homes.

16. A method of collecting and sharing energy efficiency on a comparative basis, the method comprising:
collecting audio of HVAC equipment within a home cycling on and off using a microphone;
analyzing the audio of the HVAC equipment to determine HVAC equipment state information indicating the cycling on and off of the HVAC equipment;
associating indoor temperature data and outdoor temperature data with the HVAC equipment state information;
determining using a processor, energy efficiency for the building structure using the indoor temperature data, the outdoor temperature data, and the HVAC equipment state information;
displaying energy efficiency for the building structure in comparison to a plurality of other building structures to show the energy efficiency for the building structure on the comparative basis.
